(19) United States
(12) Patent Application Publication
(10) Pub. No.: US 2009/0179498 A1
(43) Pub. Date: Jul. 16, 2009

(54) TRANSFER SWITCH CONTROLLER PROVIDING AN ALTERNATING CURRENT VOLTAGE TO A GENERATOR AND TRANSFER SWITCH INCLUDING THE SAME

(76) Inventors: TODD M. LATHROP, Oakdale, PA (US); Bert Popovich, Carnegie, PA (US); Jacob A. Hjemvick, Pittsburgh, PA (US)

Correspondence Address: Martin J. Moran, 1000 Cherrington Parkway, Moon Township, PA, 15108, US

(21) Appl. No.: 12/013,663

(22) Filed: Jan. 14, 2008

(51) Int. Cl. H02J 9/06; H01H 47/32

(52) U.S. Cl. 307/68; 307/81; 361/187

(57) ABSTRACT

A transfer switch controller is for a transfer switch. The transfer switch controller includes a first input having an alternating current voltage and structured to input power from a utility power source, second inputs structured to input remote or local signals, and an output structured to output an alternating current voltage to a standby generator. A normally closed switch, such as a relay, includes a number of normally closed contacts electrically connected between the first input and the output. The normally closed contacts are normally closed to cause the alternating current voltage of the first input to be normally output to the alternating current voltage of the output. A microprocessor cooperates with the second inputs and the normally closed switch. The microprocessor causes the normally closed switch to open responsive to one or more of the remote or local signals.

### BACKGROUND OF THE INVENTION

1. Field of the Invention

This invention pertains generally to transfer mechanisms and, more particularly, to transfer switches for selectively feeding power from one of two input lines to a load. The invention also pertains to transfer switch controllers for transfer switches.

2. Background Information

Alternate power sources are provided for any number of applications, which cannot withstand a lengthy interruption in electric power. Typically, power is provided from a primary source with back-up power provided by a secondary source. Often, the primary source is a utility power source and the secondary source is an auxiliary power source, such as an engine driven generator or a second utility source. The transfers between the two power sources can be made automatically or manually.

Transfer switches are well known in the art. See, for example, U.S. Pat. Nos. 6,849,967; 6,801,109; 5,397,868; 5,210,685; 4,894,796; and 4,747,061. Transfer switches operate, for example, to transfer a power consuming load from a circuit with a normal power supply to a circuit with an auxiliary power supply. Applications for transfer switches include stand-by applications, among others, in which the auxiliary power supply stands-by if the normal power supply should fail. Facilities having a critical requirement for continuous electric power, such as hospitals, certain plant processes, computer installations, and the like, have a standby power source, often a diesel generator. A transfer switch controls electrical connection of the utility lines and the diesel generator to the facility load buses. In many installations, the transfer switch automatically starts the standby generator and connects it to the load bus upon loss of utility power, and reconnects the utility power to the load bus if utility power is reestablished.

Transfer switches commonly used to connect alternate power sources to a load, including networks, utilize a pair of power contacts each connecting one of the sources to the load. In order to prevent connecting unsynchronized sources together, the operation of the two power contacts is coordinated, typically by an interlock mechanism (e.g., mechanical and/or electrical), in order that only one power contact at a time can be turned on. In many instances, it is desirable to operate the transfer switch remotely. Typically, electric motors or solenoids have been used to operate the interlock mechanism on transfer switches. See, for example, U.S. Pat. Nos. 5,081,367; 4,760,278; and 4,398,097.

A transfer switch typically comprises a pair of power contacts, power contactors or circuit interrupters combined with a drive input and a linkage system. The preferred types of circuit interrupters have been molded-case switches and molded-case circuit breakers because these types are commercially available in a wide array of sizes and are relatively economical compared to other options. The preferred type of drive input depends on the application for the transfer switch. Usually motors are preferred, but at other times there is a clear preference for manually-operated mechanisms.

Transfer switches as applied, for example, to light commercial and residential applications are becoming popular since a number of such commercial and residential facilities find it necessary to install backup power generation systems. Furthermore, the National Electrical Code (NEC) requires transfer equipment on all permanently installed optional standby systems. Many such transfer switches include fixed timers, voltage sensing and engine start contacts.

Underwriters Laboratories (UL) standard UL 1008 covers transfer switch equipment including automatic, non-automatic (manual) and by-pass/isolation transfer switches intended for use in ordinary locations to provide for lighting and power. Relatively low cost transfer switches that meet this standard design are suitable for many light commercial and residential applications.

It is known to provide a transfer switch for a utility power source and a generator power source. For example, U.S. Pat. No. 6,181,028 discloses a transfer mechanism for a utility power source and a generator power source. A monitoring circuit within a transfer mechanism cabinet is operatively connected to the utility power source and the generator power source. As is conventional, the monitoring circuit monitors the power supplied by the utility power source. In response to a power outage from the utility power source, the monitoring circuit starts the internal combustion engine of the generator power source. The starting of the internal combustion motor causes the electrical generator of the generator power source to generate electrical power.

Known standby generators employ one of three different forms of control signals in order to initiate a remote start.

FIG. 1 shows a transfer switch controller (TSC) 2 used to start a standby generator (SBG) 4 (shown in phantom line drawing). The TSC 2 employs a normally open contact (NO) 6, which closes to send a direct current (DC) voltage signal (e.g., a start command signal) 8, such as from a generator battery voltage 10 (shown in phantom line drawing), to cause a starter (generator control) 12 (shown in phantom line drawing) to start the standby generator 4. This is a typical mode of engine start in the standby generator market. The remote engine start signal 8 is provided from the normally open contact 6, which closes to send the start command signal 8 from the generator battery voltage 10 to the starter 12.

FIG. 2 shows another transfer switch controller (TSC) 22 used to start a standby generator (SBG) 24 (shown in phantom line drawing). The TSC 22 employs a normally closed contact (NC) 26, which opens to remove a direct current (DC) voltage signal (e.g., a start command signal) 28, such as from a generator battery voltage 30 (shown in phantom line drawing), to cause a starter (generator control) 32 (shown in phantom line drawing) to start the standby generator 24. In this mode of engine start in the standby generator market, the corresponding logic is the reverse of the logic employed by the TSC 2 of FIG. 1. Here, if a control conductor, such as 34 or 36 (shown in phantom line drawing), is broken, removed, loose or otherwise open, then the generator start is initiated. The voltage signal for the normally closed contact 26 is provided from the generator battery voltage 30.

Most known transfer switch controllers or transfer switches contain one or both of the above described normally open and closed contacts 6,26, which output DC generator start command signals.

In another mode of engine start in the standby generator market, a standby generator made by Briggs & Stratton® senses an alternating current (AC) reference signal from a primary source (e.g., without limitation, utility) and starts the generator when that source is lost. The AC reference signal usually is used by the standby generator for battery charging and engine starting. No known transfer switch controller or transfer switch controls that AC reference signal.

There is, therefore, room for improvement in transfer switches.

There is also room for improvement in transfer switch controllers for transfer switches.

### SUMMARY OF THE INVENTION

These needs and others are met by embodiments of the invention, in which a transfer switch controller normally outputs an alternating current voltage to a generator and, also, removes that alternating current voltage responsive to a number of signals, in order to start the generator.

In accordance with one aspect of the invention, a transfer switch controller for a transfer switch comprises: a first input structured to input power from a power source, the first input having an alternating current voltage; a number of second inputs structured to input a number of signals; an output structured to output an alternating current voltage to a generator; a normally closed switch electrically connected between the first input and the output, the normally closed switch being normally closed to cause the alternating current voltage of the first input to be normally output to the alternating current voltage of the output; and a circuit cooperating with the number of second inputs and the normally closed switch, the circuit being structured to cause the normally closed switch to open responsive to at least one of the number of signals.

The circuit may comprise a processor. The number of signals may have an active state and an inactive state; the normally closed switch may be a relay including an input and a number of normally closed contacts; and the processor may comprise a routine, a number of inputs structured to receive the number of signals, and an output structured to energize the input of the relay, the routine being structured to determine the active state of the number of signals and responsively cause the output of the processor to energize the input of the relay and open the number of normally closed contacts.

One of the number of signals may be a remote signal including an active state and an inactive state; and the circuit may be further structured to cause the normally closed switch to open responsive to the active state of the remote signal.

The number of signals may have an active state and an inactive state; the alternating current voltage of the first input may have a normal state and an undervoltage state; and the circuit may be further structured to cause the normally closed switch to open when the number of signals have the inactive state and when the alternating current voltage of the first input has the undervoltage state.

The circuit may comprise a timer structured to output one of the number of signals to a corresponding one of the number of second inputs; the one of the number of signals of the corresponding one of the number of second inputs may have an active state and an inactive state; and the circuit may be further structured to cause the normally closed switch to open responsive to the active state.

As another aspect of the invention, a transfer switch comprises: a first input structured to input power from a first power source, the first input having an alternating current voltage; a second input structured to input power from a second power source; a first output structured to output power to a load; a second output structured to output an alternating current voltage to a generator; a transfer mechanism structured to selectively electrically connect one of the first input and the second input to the first output; and a control mechanism cooperating with the first input, the second input and the transfer mechanism to cause the transfer mechanism to electrically connect one of the first input and the second input to the first output, the control mechanism comprising: a number of third inputs structured to input a number of signals, a normally closed switch electrically connected between the first input and the second output, the normally closed switch being normally closed to cause the alternating current voltage of the first input to be normally output to the alternating current voltage of the second output, and a circuit cooperating with the number of third inputs and the normally closed switch, the circuit being structured to cause the normally closed switch to open responsive to at least one of the number of signals.

### BRIEF DESCRIPTION OF THE DRAWINGS

A full understanding of the invention can be gained from the following description of the preferred embodiments when read in conjunction with the accompanying drawings in which:

FIG. 1 is a block diagram of a transfer switch controller, which closes a normally open contact to send a direct current (DC) voltage signal, such as a generator battery voltage, to start a standby generator.

FIG. 2 is a block diagram of a transfer switch controller, which opens a normally closed contact to remove a DC voltage signal, such as a generator battery voltage, to start a standby generator.

FIG. 3 is a block diagram of a transfer switch controller, which starts a standby generator by removing a utility alternating current (AC) voltage in accordance with embodiments of the invention.

FIG. 4 is a block diagram of a transfer switch including a transfer switch controller in accordance with other embodiments of the invention.

FIG. 5 is a block diagram of a transfer switch controller in accordance with another embodiment of the invention.

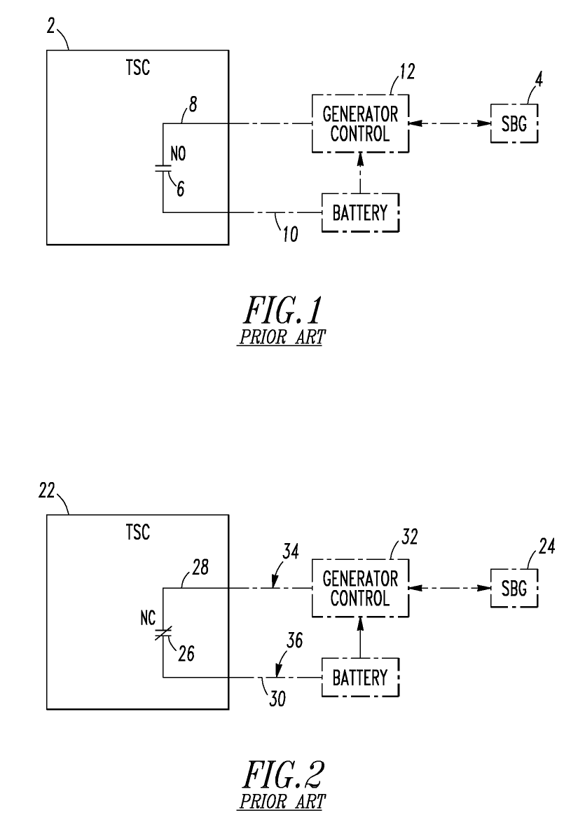

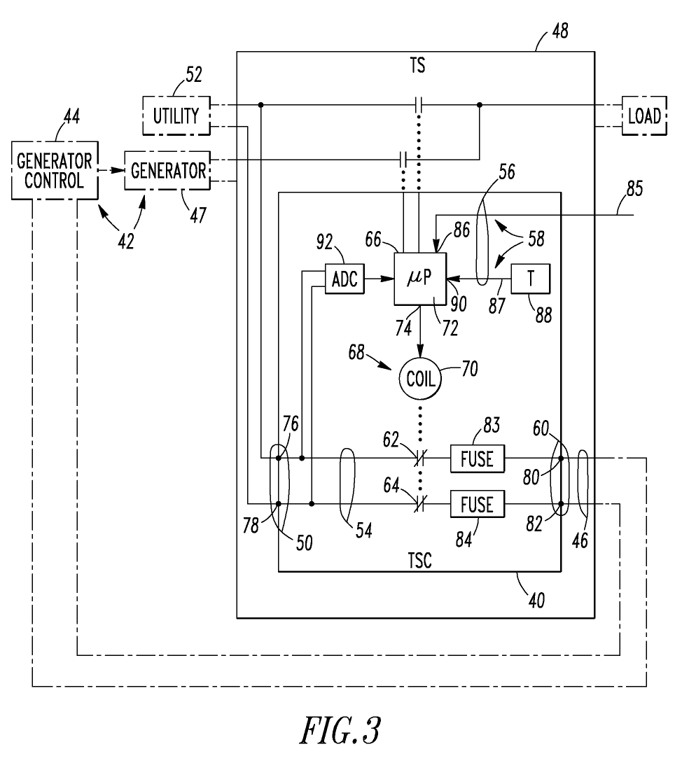

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “normally closed switch” means a mechanical, electromechanical or electronic switch that is normally closed (e.g., without limitation, by being energized or de-energized, by being actuated or de-actuated, or by being otherwise commanded to close), and that is opened responsive to a signal, such as a remote signal and/or a local signal. For example and without limitation, a wide range of switches such as solid state separable contacts, solid state or FET switches, contactor contacts, or solid state based control devices (e.g., without limitation, drives; soft-starters) may be employed.

Referring to FIG. 3, a transfer switch controller (TSC) 40 and a generator, such as the example standby generator 42 (shown in phantom line drawing), are shown. The standby generator 42 includes a starter (generator control) 44 (shown in phantom line drawing), which employs the removal (or undervoltage state) of an alternating current (AC) voltage 46 to start a generator 47 (shown in phantom line drawing) thereof. The transfer switch controller 40, which is for a transfer switch (TS) 48, includes a first input 50 structured to input power from a power source, such as the example utility power source 52 (shown in phantom line drawing). The first input 50 has an AC voltage 54, which is the AC voltage from the example utility power source 52. The transfer switch controller 40 also includes a number of second inputs 56 (e.g., without limitation, two are shown, although one, three or more may be employed) structured to input a number of signals 58 (e.g., without limitation, two are shown, although one, three or more may be employed), an output 60 structured to output the AC voltage 46 to the starter 44 of the standby generator 42, and a normally closed switch, such as a switch including the example number of normally closed contacts 62,64 (e.g., without limitation, two are shown, although one may be employed), electrically connected between the first input 50 and the output 60. The normally closed contacts 62,64 are normally closed to cause the AC voltage 54 of the first input 50 to be normally output to the AC voltage 46 of the output 60. A circuit, such as the example processor (μP) 66, cooperates with the number of second inputs 56 and the normally closed switch. The μP 66 is structured to cause the normally closed contacts 62,64 to open responsive to at least one of the number of signals 58.

Although a first input 50 and an output 60 are shown as part of the transfer switch controller 40, such input and output may be shared with the transfer switch 48 or, alternatively, a separate input and output may be employed by the transfer switch 48.

Each of the example signal(s) 58 has one of an active state and an inactive state. The example normally closed switch is a relay 68 including an input (e.g., a coil 70) and the example normally closed contacts 62,64. The μP 66 includes a routine 72, the second input(s) 56 that receive the signal(s) 58, and an output 74 structured to energize the relay coil 70. The μP routine 72 is structured to determine the active state(s) of the number of signals 58 and responsively cause the μP output 74 to energize the relay coil 70 and open the normally closed contacts 62,64.

The example first input 50 includes two input terminals 76,78. The example output 60 of the transfer switch controller 40 includes two output terminals 80,82. Each of the example two normally closed contacts 62,64 is electrically connected in series between a corresponding one of the two input terminals 76,78 and a corresponding one of the two output terminals 80,82, respectively. The example output 60 also includes two fuses 83,84. Each of the two fuses 83,84 is electrically connected in series with a corresponding one of the normally closed contacts 62,64 between a corresponding one of the two input terminals 76,78 and a corresponding one of the two output terminals 80,82, respectively.

Although input terminals 76,78 and output terminals 80,82 are shown as part of the transfer switch controller 40, such terminals may be shared with the transfer switch 48 or, alternatively, separate terminals may be employed by the transfer switch 48.

The example signal(s) 58 include a remote signal 85 (e.g., without limitation, a remote Go To Generator signal) including an active state and an inactive state and corresponding to μP input 86. The μP routine 72 is further structured to cause the example relay coil 70 to be energized from the μP output 74 and the normally closed contacts 62,64 to be opened responsive to the active state of the remote signal 85.

The example signal(s) 58 also include a local signal 87 (e.g., without limitation, a local Plant Exercise signal) from a timer (T) 88. The timer 88 is operatively associated with the μP 66 and is structured to suitably periodically or repetitively output the local signal 87 corresponding to μP input 90 with an active state and an inactive state. The μP routine 72 is further structured to cause the relay coil 70 to be energized and the normally closed contacts 62,64 to be opened responsive to the active state of the local signal 87.

The AC voltage 54 from the utility power source 52 has a normal state (e.g., without limitation, rated AC voltage) and an undervoltage state (e.g., without limitation, about 70% below the rated AC voltage; below any suitable reference AC voltage). The μP routine 72 is further structured to cause the example relay coil 70 to be energized and the normally closed contacts 62,64 to be opened responsive to the undervoltage state of the AC voltage 54 as is determined by μP 66 through analog-to-digital converter (ADC) 92.

The AC voltages 46,54 may be, for example and without limitation, one of a phase-to-ground voltage, a phase-to-neutral voltage, a phase-to-phase voltage, a line-to-ground voltage, a line-to-neutral voltage, and a line-to-line voltage.

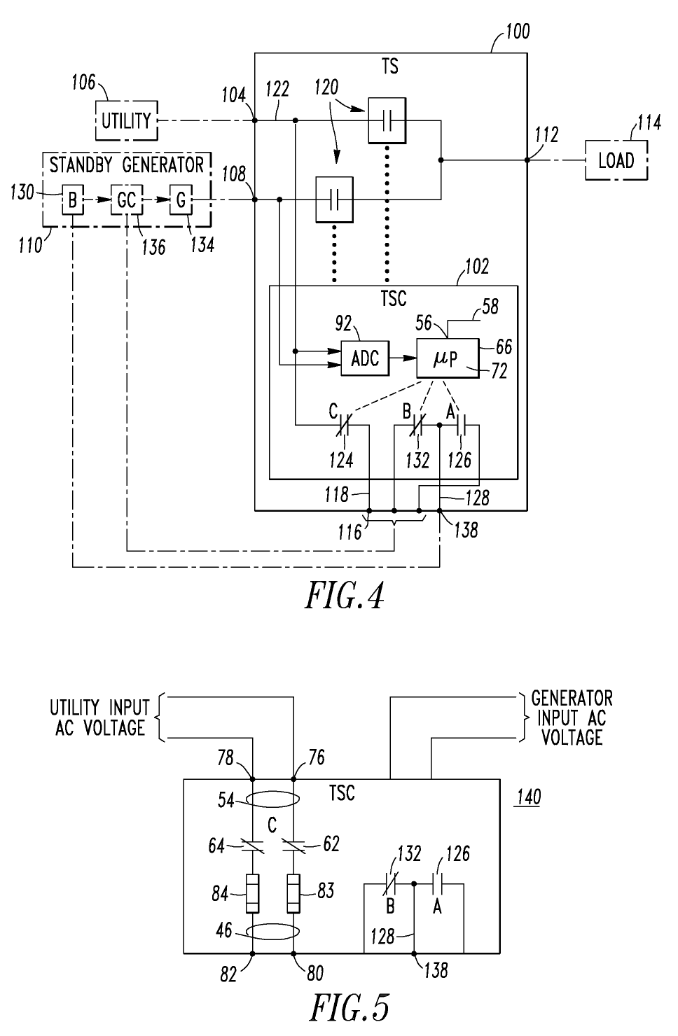

Referring to FIG. 4, a transfer switch (TS) 100 includes a transfer switch controller (TSC) 102, which may be the same as or similar to the transfer switch controller 40 of FIG. 3. The transfer switch controller 102 includes the μP 66, the routine 72 and the number of input(s) 56 that receive the number of signal(s) 58 of FIG. 3. The transfer switch 100 includes a first input 104 structured to input power from a first power source, such as the example utility power source 106 (shown in phantom line drawing), a second input 108 structured to input power from a second power source, such as the example standby generator (shown in phantom line drawing) 110, a first output 112 structured to output power to a load 114 (shown in phantom line drawing), and a second output 116 structured to output an AC voltage 118 to the example standby generator 110. As is conventional, a suitable transfer mechanism 120 is structured to selectively electrically connect one of the first input 104 and the second input 108 to the first output 112.

A suitable control mechanism is provided by the transfer switch controller 102. The transfer switch controller 102 cooperates with the first input 104, the second input 108 and the transfer mechanism 120 to cause the transfer mechanism 120 to electrically connect one of the first input 104 and the second input 108 to the first output 112. The first input 104 has an AC voltage 122 that is input by the transfer switch controller 102. In this example, the utility power source 106, the standby generator 110, the load 114 and the transfer switch controller 102 use the same ground and/or neutral (not shown) to which AC voltages, such as 118 and 122 are referenced. Here, there is a single normally closed switch, such as the example normally closed Contact C 124 electrically connected between the first input 104 and the second output 116. This normally closed switch is normally closed to cause the AC voltage 122 of the first input 104 to be normally output to the AC voltage 118 of the second output 116.

As was similarly discussed above in connection with FIG. 3, the μP 66 and the routine 72 cooperate with the number of input(s) 56 and the number of signal(s) 58 and cause the normally closed Contact C 124 to open responsive to one or more of the signal(s) 58.

In FIG. 4, the transfer switch controller 102 also includes a normally open Contact A 126 structured to receive a battery voltage 128 from a battery (B) 130 (shown in phantom line drawing) of the standby generator 110, and a normally closed Contact B 132 structured to receive the same battery voltage 128. Here, the μP routine 72 is also structured to cause the normally open Contact A 126 to close responsive to one or more of the signal(s) 58 and to cause the normally closed Contact B 132 to open responsive to one or more of the signal(s) 58. The μP routine 72 is also structured to cause the normally open Contact A 126 to close, the normally closed Contact B 132 to open, and the normally closed Contact C 124 to open when the signal(s) 58 have the inactive state and when the AC voltage 122 of the first input 104 has an undervoltage state as determined by the μP 66 through the ADC 92.

The μP routine 72 is further structured to selectively cause the transfer mechanism 120 to electrically connect the second input 108 to the first output 112 in order to provide a generator loaded condition for the generator 134 (shown in phantom line drawing) of the standby generator 110 responsive to the active state of one of the signal(s) 58.

The μP routine 72 is further structured to selectively cause the transfer mechanism 120 to electrically connect the first input 104 to the first output 112 in order to provide a generator unloaded condition for the generator 134 of the standby generator 110 responsive to the active state of one of the signal(s) 58.

The example transfer switch controller 102 includes three generator control circuits in the form of the example contacts A 126, B 132 and C 124, which isolate the AC and direct current (DC) signals employed by different standby generator start circuits, such as starter (GC) 136. These generator control circuits are handled either separately and/or together within the transfer switch controller 102. This allows for an easy input to the transfer switch controller 102 to provide remote control of standby generators, such as 110, without added components.

Contact A 126 is employed by those standby generators that employ a contact closure to provide a generator start signal. Typically, the generator battery voltage 128 is provided at common input 138 to normally open Contact A 126. When this Contact A 126 closes, the generator battery voltage 128 is returned to the starter 136 of the standby generator 110. This Contact A 126 closes, for example and without limitation, upon utility power outages, generator exercises (e.g., Plant Exercise), and Utility Load Shedding (e.g., Go To Generator input).

Contact B 132 is employed by those standby generators that employ a contact opening to provide a generator start signal. This employs reverse logic as compared to the logic of Contact A 126 and provides an engine start upon, for example and without limitation, a loose, broken or removed control conductor between the transfer switch controller 102 and the standby generator 110. Typically, the generator battery voltage 128 is provided at common input 138 to normally closed Contact B 132. When this Contact B 132 opens, the generator battery voltage 128 is removed from the starter 136 of the standby generator 110. This Contact B 132 opens, for example and without limitation, upon utility power outages, generator exercises (e.g., Plant Exercise), and Utility Load Shedding (e.g., Go To Generator input).

Contact C 124 is employed by those standby generators that sense a utility AC voltage to provide a start signal. The standby generator 110 functions as designed upon a utility outage and starts. Furthermore, in this embodiment, other local or remote input(s) 56 are able to control the utility sensing and initiate a generator start. Hence, inputs such as, for example and without limitation, generator exercises (e.g., Plant Exercise), and Utility Load Shedding (e.g., Go To Generator input), are able to be employed on this type of standby generator 110. This is discussed, below, in connection with the logic of Table 1. The normally closed Contact C 124 opens upon receipt of the local or remote input(s) 56 and removes the utility AC voltage 122 from the starter 136 of the standby generator 110. This causes the generator 134 to start and remain running until Contact C 124 is again closed and the utility AC voltage 122 is returned to the standby generator starter 136.

No known transfer switch controller or transfer switch contains or controls the above described Contact C 124 or the contacts 62,64 of FIG. 3.

The example routine 72 of FIGS. 3 and 4 employs suitable μP logic to drive contacts A 126, B 132 and C 124 (or contacts 62,64). Table 1, below, provides a truth table for these contacts 126,132,124 (or contacts 62,64) for the example transfer switch controllers 40 or 102, respectively, along with the inputs that may drive those contacts.

TABLE 1

| | | | Output Engine | | |
|---|---|---|---|---|---|
| Inputs | | | Start Contacts | | |
| Utility Power | Go To Generator | Plant Exercise | A | B | C |
| 1 | 0 | 0 | 0 | 1 | 1 |
| 1 | 1 | 0 | 1 | 0 | 0 |
| 1 | 0 | 1 | 1 | 0 | 0 |
| 1 | 1 | 1 | 1 | 0 | 0 |
| 0 | 0 | 0 | 1 | 0 | 1 |
| 0 | 1 | 0 | 1 | 0 | 0 |
| 0 | 0 | 1 | 1 | 0 | 1 |
| 0 | 1 | 1 | 1 | 0 | 0 |

For the example inputs (Utility Power, Go To Generator, and Plant Exercise), a logic “1” means that an input is available, within specification or initiated, and a logic “0” means that an input is not available, not within specification or not initiated. For the example outputs provided by contacts A 126, B 132 and C 124 (or contacts 62,64), a logic “1” means made or closed, and a logic “0” means not made or opened.

The first row of Table 1 is the normal state where the utility power is present (as determined by the AC voltage 54 of FIG. 3 or the AC voltage 122 of FIG. 4) and there is no Go To Generator input remote signal, such as 85 of FIG. 3, and no Plant Exercise internal signal, such as 87 of FIG. 3. In FIG. 4, normally open Contact A 126 remains open, in order that the generator battery voltage 128 is not returned to the standby generator 110, normally closed Contact B 132 remains closed, in order that the generator battery voltage 128 is applied to the standby generator 110, and normally closed Contact C 124 (or contacts 62,64 of FIG. 3) remain closed, in order that the utility AC voltage 122 (AC voltage 54 of FIG. 3) is applied to the standby generator 42,110. All of these prevent the standby generator 110 from starting.

In the bottom seven rows of Table 1, there is one, some or all of the utility power not being present (as determined by the AC voltage 54 of FIG. 3 or the AC voltage 122 of FIG. 4), a Go To Generator input remote signal 85, and/or a Plant Exercise internal signal 87. Any one, some or all of these conditions cause the start of the standby generator 42,110 through Contact A 126 or Contact B 132.

In the example embodiment, Contact C 124 functions in a corresponding manner, except that in the fifth and seventh rows of Table 1, Contact C 124 does not cause the start of the standby generator 42,110 if there is no Go To Generator input.

The Go To Generator input remote signal 85 (FIG. 3) is a remote input that can be given to the transfer switch controller 40,102 (e.g., without limitation, by a utility; by another remote input) that: (1) sends a start signal to the generator 134 by opening Contacts B 132 and C 124, and closing Contact A 126; (2) when the voltage and frequency of the generator 134 are within specification, causes the transfer switch 100 to load the generator 134 (and shed load from the utility 106); and (3) maintains the load shed from the utility 106 until the remote signal 85 is removed.

The Plant Exercise internal signal 87 (FIG. 3) is an internally controlled function of the transfer switch 48,100 or transfer switch controller 40,102 that runs the generator 47,134 on a timed basis to keep its engine (not shown) lubricated. Some generators (not shown) have an exercise function integral to the generator that allows for an unloaded exercise cycle only. However, with the example engine start (Contacts C 124 (or contacts 62,64) on the transfer switch controller 102,40, this can complete both a Loaded (i.e., the number of loads, such as 114, are powered from the generator 134) and an Unloaded (i.e., the number of loads, such as 114, are powered from the utility 106) exercise cycle. Hence, the disclosed transfer switch 48,100 and transfer switch controller 40,102 provide additional options for control.

Non-limiting examples of transfer switch control functions include Automatic Generator Start, Remote Utility Load Shedding, Generator Exercise, and Remote Generator Load/No Load Test.

FIG. 5 shows a transfer switch controller 140, which is similar to the transfer switch controller 40 of FIG. 3, except that it also includes the normally closed Contact B 132 and the normally open Contact A 126. Hence, this transfer switch controller 140 preferably incorporates all of the three disclosed modes of remote standby generator start control.

The disclosed transfer switch controllers 102,140 and the disclosed transfer switch 100 can be used with any manufacturer's standby generator without special wiring of the transfer switch or the standby generator, such as 42 or 110. Hence, a single transfer switch is suitable for all known standby generators.

Although the example Go To Generator input remote signal 85 and the example Plant Exercise local signal 87 are disclosed, the invention is applicable to any local or remote input or signal to or for a transfer switch or transfer switch controller.

Although a relay 68 is disclosed with normally closed contacts 62,64, which are closed when the relay coil 70 is de-energized and which are open when the relay coil 70 is energized, the invention is applicable to a wide range of relays and other switching apparatus that provide a number of contacts or switches that are closed when the relay or other switching apparatus is energized, otherwise actuated or otherwise commanded to close, and that are open when the relay or other switching apparatus is de-energized, otherwise de-actuated or otherwise commanded to open.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A transfer switch controller for a transfer switch, said transfer switch controller comprising:
a first input structured to input power from a power source, said first input having an alternating current voltage;
a number of second inputs structured to input a number of signals;
an output structured to output an alternating current voltage to a generator;
a normally closed switch electrically connected between said first input and said output, said normally closed switch being normally closed to cause the alternating current voltage of said first input to be normally output to the alternating current voltage of said output; and
a circuit cooperating with said number of second inputs and said normally closed switch, said circuit being structured to cause said normally closed switch to open responsive to at least one of said number of signals.

2. The transfer switch controller of claim 1 wherein said circuit comprises a processor.

3. The transfer switch controller of claim 2 wherein said number of signals have an active state and an inactive state; wherein said normally closed switch is a relay including an input and a number of normally closed contacts; and wherein said processor comprises a routine, a number of inputs structured to receive said number of signals, and an output structured to energize the input of said relay, said routine being structured to determine the active state of said number of signals and responsively cause the output of said processor to energize the input of said relay and open said number of normally closed contacts.

4. The transfer switch controller of claim 3 wherein said first input comprises two input terminals; wherein said output of said transfer switch controller comprises two output terminals; and wherein said number of normally closed contacts are two normally closed contacts, each of said two normally closed contacts being electrically connected in series between a corresponding one of said two input terminals and a corresponding one of said two output terminals.

5. The transfer switch controller of claim 1 wherein said first input comprises two input terminals; wherein said output comprises two output terminals; and wherein said normally closed switch comprises two normally closed contacts, each of said two normally closed contacts being electrically connected in series between a corresponding one of said two input terminals and a corresponding one of said two output terminals.

6. The transfer switch controller of claim 1 wherein said first input comprises two input terminals; and wherein said output comprises two fuses and two output terminals, each of said two fuses being electrically connected in series between a corresponding one of said two input terminals and a corresponding one of said two output terminals.

7. The transfer switch controller of claim 1 wherein said circuit comprises a normally open contact structured to receive a battery voltage and a normally closed contact structured to receive said battery voltage; and wherein said circuit is further structured to cause said normally open contact to close responsive to at least one of said number of signals and to cause said normally closed contact to open responsive to at least one of said number of signals.

8. The transfer switch controller of claim 1 wherein said circuit comprises a normally open contact structured to receive a battery voltage and a normally closed contact structured to receive said battery voltage; wherein said number of signals have an active state and an inactive state; wherein the alternating current voltage of said first input has a normal state and an undervoltage state; and wherein said circuit is further structured to cause said normally open contact to close, said normally closed contact to open, and said normally closed switch to open when said number of signals have the inactive state and when the alternating current voltage of said first input has the undervoltage state.

9. The transfer switch controller of claim 1 wherein one of said number of signals is a remote signal including an active state and an inactive state; and wherein said circuit is further structured to cause said normally closed switch to open responsive to said active state of said remote signal.

10. The transfer switch controller of claim 1 wherein said number of signals have an active state and an inactive state; wherein the alternating current voltage of said first input has a normal state and an undervoltage state; and wherein said circuit is further structured to cause said normally closed switch to open when said number of signals have the inactive state and when the alternating current voltage of said first input has the undervoltage state.

11. The transfer switch controller of claim 1 wherein said circuit comprises a timer structured to output one of said number of signals to a corresponding one of said number of second inputs; wherein said one of said number of signals of the corresponding one of said number of second inputs has an active state and an inactive state; and wherein said circuit is further structured to cause said normally closed switch to open responsive to said active state.

12. A transfer switch comprising:
a first input structured to input power from a first power source, said first input having an alternating current voltage;
a second input structured to input power from a second power source;
a first output structured to output power to a load;
a second output structured to output an alternating current voltage to a generator;
a transfer mechanism structured to selectively electrically connect one of said first input and said second input to said first output; and
a control mechanism cooperating with said first input, said second input and said transfer mechanism to cause said transfer mechanism to electrically connect one of said first input and said second input to said first output, said control mechanism comprising:
a number of third inputs structured to input a number of signals,
a normally closed switch electrically connected between said first input and said second output, said normally closed switch being normally closed to cause the alternating current voltage of said first input to be normally output to the alternating current voltage of said second output, and
a circuit cooperating with said number of third inputs and said normally closed switch, said circuit being structured to cause said normally closed switch to open responsive to at least one of said number of signals.

13. The transfer switch of claim 12 wherein said circuit comprises a normally open contact structured to receive a battery voltage, said circuit being further structured to cause said normally open contact to close responsive to at least one of said number of signals.

14. The transfer switch of claim 12 wherein said circuit comprises a normally closed contact structured to receive a battery voltage, said circuit being further structured to cause said normally closed contact to open responsive to at least one of said number of signals.

15. The transfer switch of claim 12 wherein one of said number of signals is a remote signal having an active state and an inactive state; and wherein said circuit is further structured to cause said normally closed switch to open responsive to said active state.

16. The transfer switch of claim 12 wherein said control mechanism further comprises a timer structured to output one of said number of signals to a corresponding one of said number of third inputs; wherein said one of said number of signals of the corresponding one of said number of third inputs has an active state and an inactive state; and wherein said circuit is further structured to cause said normally closed switch to open responsive to said active state.

17. The transfer switch of claim 12 wherein said circuit comprises a normally open contact structured to receive a battery voltage and a normally closed contact structured to receive said battery voltage; and wherein said circuit is further structured to cause said normally open contact to close responsive to at least one of said number of signals and to cause said normally closed contact to open responsive to at least one of said number of signals.

18. The transfer switch of claim 12 wherein said circuit comprises a normally open contact structured to receive a battery voltage and a normally closed contact structured to receive said battery voltage; wherein said number of signals have an active state and an inactive state; wherein the alternating current voltage of said first input has a normal state and an undervoltage state; and wherein said circuit is further structured to cause said normally open contact to close, said normally closed contact to open, and said normally closed switch to open when said number of signals have the inactive state and when the alternating current voltage of said first input has the undervoltage state.

19. The transfer switch of claim 12 wherein one of said number of signals includes an active state and an inactive state; and wherein said circuit is further structured to cause said normally closed switch to open responsive to said active state of said one of said number of signals.

20. The transfer switch of claim 19 wherein said circuit is further structured to cause said transfer mechanism to electrically connect said second input to said first output responsive to said active state of said one of said number of signals.

21. The transfer switch of claim 19 wherein said circuit is further structured to cause said transfer mechanism to electrically connect said first input to said first output responsive to said active state of said one of said number of signals.

22. The transfer switch of claim 12 wherein said number of signals have an active state and an inactive state; wherein the alternating current voltage of said first input has a normal state and an undervoltage state; and wherein said circuit is further structured to cause said normally closed switch to open when said number of signals have the inactive state and when the alternating current voltage of said first input has the undervoltage state.

23. The transfer switch of claim 12 wherein said second output comprises at least one fuse electrically connected in series between said first input and said second output.
